(19) United States
(12) Patent Application Publication
(10) Pub. No.: US 2018/0130139 A1
(43) Pub. Date: May 10, 2018

(54) Friend Matching Application

(71) Applicant: Christopher Jordan Hurley, Highland, UT (US)

(72) Inventor: Christopher Jordan Hurley, Highland, UT (US)

(21) Appl. No.: 15/807,567

(22) Filed: Nov. 8, 2017

Related U.S. Application Data
(60) Provisional application No. 62/419,318, filed on Nov. 8, 2016.

(51) Int. Cl. G06Q 50/00; G06F 7/02; G06F 17/30

(52) U.S. Cl. CPC G06Q 50/01; G06F 17/30867; G06F 7/02

(57) ABSTRACT

A system and method for third-party matchmaking in an online or electronic dating app or system. A search friend may review user profiles to select potential matches for a find friend. Generating a match may require approval from one or more trusted users, or confirmation through a voting or similar mechanism. A user's matchmaking prowess may be ranked or scored based on success and accuracy. Matches may be anonymous or non-anonymous. A user desiring to be matched may seek out and request that a particular search user identify matches.

### BACKGROUND OF THE INVENTION

The advent of online dating and matching services in recent years has greatly benefitted many people seeking relationships. Such services provide opportunities to find out about and meet people that otherwise likely would not have occurred. The flipside of the easiness and simplicity of online dating has resulted in the opposite problem: too many opportunities. Also, sometimes matches do not happen because a person seeking a match is not sufficiently objective or self-aware to identify good potential matches for himself or herself, or simply may not have sufficient time to search for potential matches, or may feel a need to rely on outside busted friends or relations, or on outside perspectives, to identify good potential matches. What is needed is an improved system and method for creating matches in online dating and/or matching services, or in other dating and/or matching services (that may not be online, or may be partially online).

### BRIEF SUMMARY OF THE INVENTION

A system and method are disclosed for facilitating input and/or participation from a third party in making, promoting, suggesting, ranking, or otherwise affecting matches in a dating/matching service such as an online dating service.

In one embodiment, this disclosed system and method may be referred to as a Friend-Driven Matching System (“FDMS”).

In one embodiment, the FDMS may present, via a smartphone, tablet, or other device, FDMS user profiles to a Search User, who may browse, filter, or otherwise review the profiles to identify a match for a Friend Match User, i.e., a FDMS user other than the search user and other than the presented user profiles. In other works, the FDMS provides a system and method whereby a friend, or other third-party user, may find dating matches for a friend, and not for himself or herself. Friends identify matches for friends instead of for themselves.

In one embodiment, the FDMS may be implemented as a smartphone app. A user may create an account by adding personal details and pictures, videos, or other information. A user may decide whether to make matches for other users, or to allow others to make matches for the user.

In one embodiment, a FDMS Search User may select another FDMS user, a Friend Match User, for whom to make matches. The FDMS may automatically determine a set of FDMS profiles, and an order, to present to the Search User. Alternatively, the Search User may search or filter to generate a set of FDMS profiles. The Search User may review the FDMS and profiles, and for each profile may determine whether to generate, or suggest generating, a match.

In one embodiment, a match may be generated only if approved by multiple “friends,” or if confirmed through a voting system or other system that combines votes or inputs from multiple users.

In one embodiment, a Search User may be a assigned a rank or score reflecting the Search User's success rate for identifying matches, e.g., the number of suggested matches that result in texting or phone calls, or the amount of resulting texting or phone calls, or the number of dates resulting from a match, or the length of a relationship resulting from a match, or the percentage of matches resulting in a reciprocal match, or the percentage of matches resulting in marriage or other long-term relationship.

In one embodiment, a FDMS user may select a particular Search User based on score or rank. A score or rank for a Search User may be limited to a particular segment of user profiles, e.g., redheads or athletes.

In one embodiment, FDMS users may identify matches for FDMS users they do not know, or with whom they are only minimally acquainted.

In one embodiment, a first user may request for a particular user to act a Search User for the first user. A first user may also request that another user, e.g., a search user, identify a match for a particular date, date and time, or date, time, and event.

Matches may be anonymous, or non-anonymous,

The FDMS may require reciprocity, e.g., matching for both users in a potential match, or may allow unilateral match generation.

### BRIEF DESCRIPTION OF THE DRAWINGS

FIG. 1 shows an exemplary FDMS interface.

FIG. 2 shows an exemplary FDMS interface.

FIG. 3 shows an exemplary FDMS interface.

FIG. 4 shows an exemplary FDMS interface.

### DETAILED DESCRIPTION OF THE INVENTION

A system and method is disclosed for matching parties, entities, or individuals, wherein the matching is driven by a party other than one of the parties being matched. The disclosure herein may also be applied to matching of entities such as services or service providers.

One application is matches for dates or relationships. In one embodiment, the Friend-Driven Matching System (“FDMS”) disclosed herein may enable a friend, or another person, to identify potential dating matches for his/her friend (or a person who may not be a friend).

In one embodiment, a FDMS may be implemented as a smartphone app. A person of ordinary skill will appreciate that a FDMS could also be implemented through many other platforms and/or paradigms known in the art, e.g., a tablet app, or a computer application, or a website, or a client-server application model. Implementations on other platforms are within the scope and spirit of the disclosure herein.

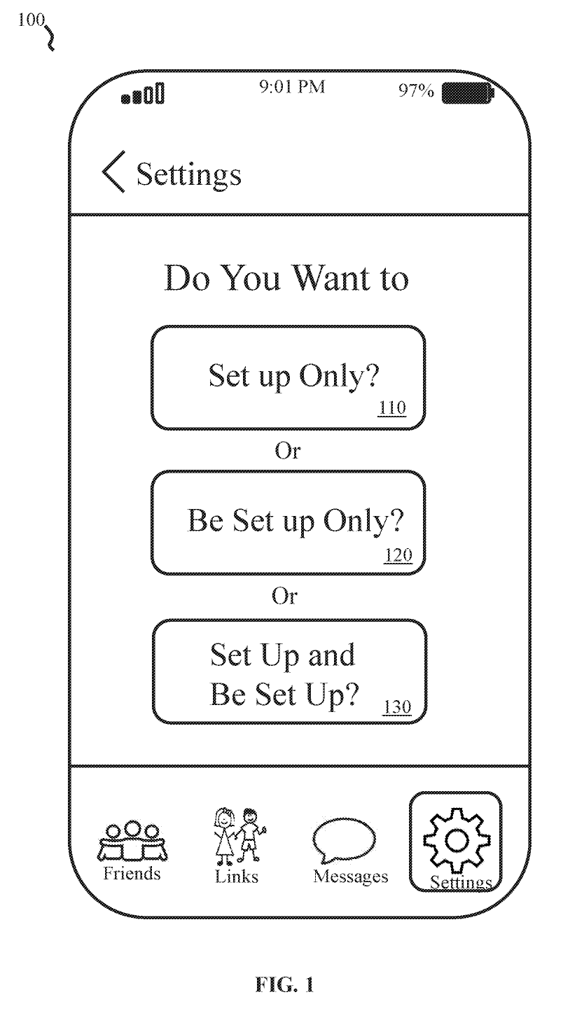

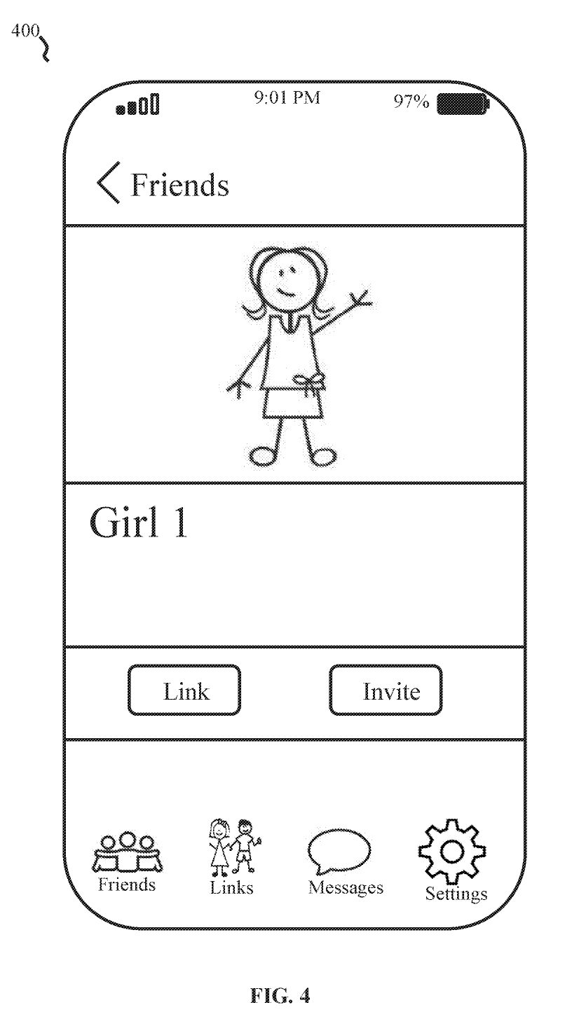

FIGS. 1-4 show selected interfaces of an exemplary embodiment of an implementation of a FDMS as a smartphone app.

For example, in one embodiment, a user may create a FDMS profile with information about the user, including but not limited to gender, age, sexual orientation, ethnicity, personality test results, personality profile, personality type, occupation, area.(s) of current or previous study, height, weight, build, geographic location, occupation, education, pets, interests, hobbies, hair color, eye color, preferred activities, religious/philosophical persuasion, family plans, emotional characteristics, social media attributes (e.g., number of friends on Facebook®), favorite books, favorite foods or restaurants, pictures, movies, exemplary artwork or writing, or any other attribute or set of attributes known in the art.

For example, for attributes/characteristics relating to personalities, the FDMS may collaborate or partner with a personality test system, e.g., 16personalities.com®, to facilitate personality tests and/or profiling, and to facilitate easy use, importing, or access of personality data in the FDMS.

A user may also input or otherwise identify similar information or attributes about desired, or good, or poor potential dating matches. In one embodiment, a FDMS user may identify “must have” attributes for a potential dating match. “Must have” attributes are, in general, attributes that a user requires any potential dating match to have. For example, a user's “must have” attributes could include (1) must love dogs, (2) must have a college degree, (3) must be taller than 5′8″, (4) must believe in Jesus Christ, and (5) must live and want to live in Wyoming.

In one embodiment, a user's “must have” attributes may be displayed, or otherwise provided, in association with a user's profile.

In one embodiment, a user may access a Settings interface to select a use mode. FIG. 1 shows an exemplary Settings interface 100 for selecting a use mode. As shown in FIG. 1, Settings interface 100 may include selections 110, 120, and 130. Selection 110 may indicate that a user desires to set up others, i.e., generate matches for other users but not to find matches for himself/herself. Selection 120 may indicate that a user desires for one or more other users to generate matches for the user, but that the user does not desire to generate matches for other users. Selection 130 may indicate that a user desires to do both, i.e., to generate matches for other users and for other uses to generate matches for that user. A user may select one of selections 110, 120, or 130 to direct the FDMS to execute in a particular mode.

In general, instead of a user searching other profiles for dating matches for himself, a user searches other profiles in search of dating matches for two users other than the searching user. To distinguish between these two user roles, i.e., the role of searching and the role of being matched, a user performing a search will hereinafter be referred to as a Search User.

In one embodiment, a Search User may use the FDMS to find one or more matches for one or more other FDMS users with FDMS profiles. In one embodiment, a FDMS user for which a Search User is looking for matches may be a friend of the Search User. In general, as is well known in the art, the Search User may login to the FDMS, i.e., through Facebook, or using credentials from any other social media, dating, or other system/account, or using FDMS credentials. Such credentials may comprise a user name and password, or fingerprint matching, a digital key, or any other credentialing system or approach known in the art.

In one embodiment, a user may select to have his or her FDMS account automatically created, in full or in part, by mining information from Facebook®, other social media account(s), or from any other repository that may have information relating to an individual's FDMS profile and/or associated attributes.

When searching for matches for a particular friend, a Search User may use the FDMS interface to identify the friend, referred to herein as a Friend Match User. In some embodiments, a Search User may also identify an FDMS interface that is not necessarily a friend, but which may be simply another FDMS user. For example, a “friend” for which matches are to be generated could be a randomly selected FDMS user, or could be an FDMS user with particular characteristics, or an FDMS user selected out of a pool of FDMS users with particular characteristics, or an FDMS user selected based on particular characteristics or based on a selection algorithm. In one embodiment, an FDMS user for which one or more matches are to be generated could be an FDMS user that has requested matches, or that has requested a particular Search User, or a particular set of Search Users, or a Search User with particular or minimum ranking or performance metrics. It should be appreciated that the user for whom a Search User is to find matches may be identified in various ways.

Once a Search User has selected a Friend. Match User, the Search user may browse or search HMS profiles for potential matches for the Friend Match User. The Search User may perform his or her own searches of FDMS profiles by searching on user profile attributes, or may request that the FDMS perform an automated search, or may employ a hybrid.

In one embodiment, the FDMS may maintain, generate, provide, and/or store one or more “dating pools” for a Friend Match User. A dating pool may comprise a set of profiles reflecting one or more particular attribute/characteristic values. For example, a dating pool may comprise a set of profiles with a particular set of characteristics or attributes, e.g., having the same or similar geographic locations, or having a particular age range, or a characteristic/attribute value or range, or combination of one or more characteristics/attributes, or any function of one or more characteristics/attributes. In one exemplary embodiment, a dating pool may be designed to be as diverse as possible, e.g., include profiles that are very different. In another exemplary embodiment, a dating pool may be designed to include multiple profiles sharing one or more common attributes/characteristics, or ranges of attributes/characteristics, or function(s) of one or more attributes/characteristics, but varying across other attributes/characteristics, or ranges of attributes/characteristics, or function(s) of attributes/characteristics. For example, a dating pool may comprise a set of profiles all having red hair, but with different heights or hobby interests.

Dating pools may be designed or generated by a user, or by the FDMS, or by multiple collaborating users, or in any other way known in the art.

In one embodiment, profiles from a dating pool may be presented to a user one at a time, and the user may have the option, for a particular presented profile, to reject, accept, link to a friend, archive, make/save notes, update attributes/characteristics, forward to another use for a second opinion, rank, rate, move or copy to another dating pool, or any other operation that may be known in the art. The user or FDMS may order the presentation of profiles in a set based on any attribute/characteristic, or set of attributes/characteristics, or function of attributes/characteristics, or randomly, or in any other ordering approach or algorithm known in the art.

In an alternate profile, multiple profiles from a dating pool may be presented to a user at one time, and the FDMS may make it possible for the user to compare, etc.

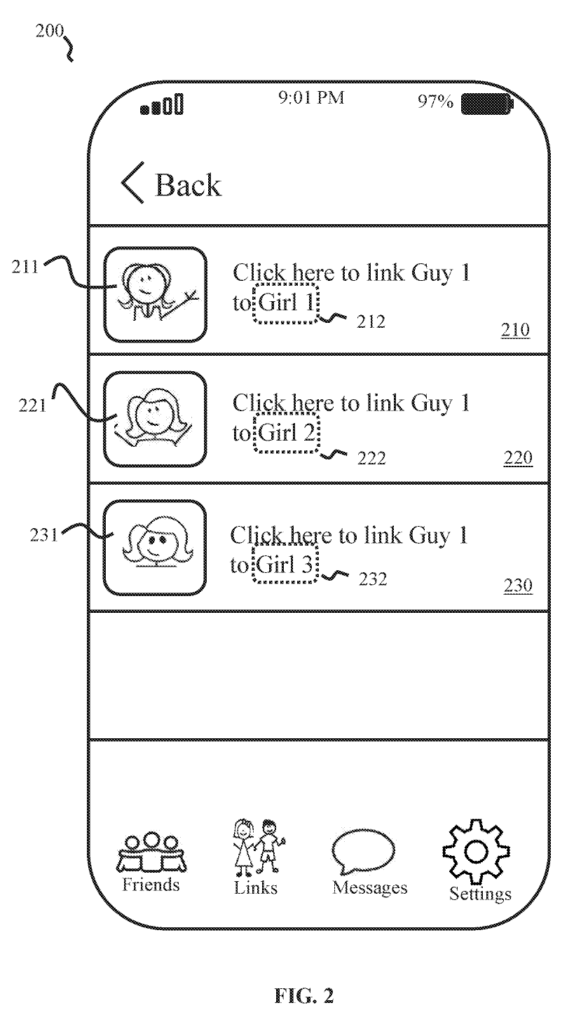

FIG. 2 shows an exemplary FDMS interface 200 for presenting one or more profiles to a Search User. For example, as shown in FIG. 2, a Search User may have selected, or the FDMS may have identified, the profile for “Guy 1” as the Friend Match User. Interface 200 may present one or more profiles for potential matching. For example, as shown in FIG. 2, interface 200 may present three profiles 210, 220, and 230 for potential matching. The amount of information presented with each profile may depend on available interface real estate, user preferences, a FDMS match viability ranking or score, or a combination of these, or on other factors that may relate to the amount of information shown for each profile. As shown in FIG. 2, in one embodiment interface 200 may show pictures 211, 221, and 231 for profiles 210, 220, and 230, respectively, and may also show user names or profile names 212, 222, and 232 for profiles 210, 220, and 230, respectively.

In one embodiment, a Search User may tap on a profile, or swipe left on a profile, or swipe right on a profile, or one of numerous other interface maneuvers known in the art to elicit additional information for a particular profile. For example, in one embodiment, a user may tap anywhere on profile display 210 to elicit additional information on profile 210.

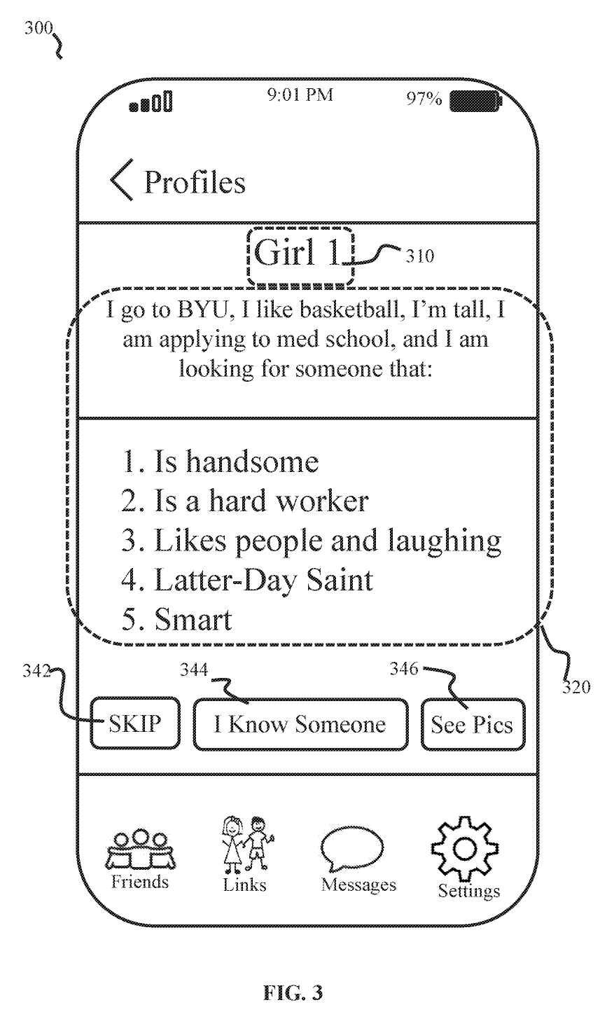

FIG. 3 shows an exemplary interface 300 for presenting additional information for a profile, e.g., profile 211 in FIG. 2. As shown in FIG. 3, interface 300 may present additional information and details for the profile for “Girl 1,” As shown in FIG. 3, profile identifier 310 may identify profile 210 as “Girl 1.” As used in profile 210 and interface 300, “Girl 1” may refer to a screen name, profile name, or a real name. Details 320 may provide details about profile 210, including but not limited to likes, dislikes, desired characteristics for a match, and many other details about profile 210.

Interface element 342 may allow a Search User to skip, i.e., determine to not match, the associated profile.

Interface element 344 may allow a Search User to find or identify a user that may be a good match. Interface element 346 may allow a Search User to see or be presented with additional information, e.g., pictures, videos, social media, etc., about the person associated with profile 210.

In one embodiment, a Search User may match from interface 300 by swiping up, or swiping left, or swiping right, or double tapping, or using one of many well-known interface interactions.

In another embodiment, a Search User may match from interface 200 by swiping right on a profile, or by using one of many well-known interface interactions.

Although the disclosure herein makes reference to presenting profile information in a visual manner, e.g., through text, pictures, videos, and other means, profile information, or any other information relevant to the disclosure herein may be presented in many other ways, e.g., audio, vibration, haptic, directions, smell, or any other interface means known in the art.

FIG. 400 shows another exemplary interface for presenting a profile for potential matching, or linking.

When the FDMS returns search results, i.e., a set of “matching” user profiles, or possibly a set of refining questions soliciting input from the Search User to perform a more refined search, the Search User may browse the search results. The Search User may select one or more search result profiles as possible matches, or may solicit further information from one or more search result profiles, or may save one or more search result profiles for later review, or may apply a ranking to one or more search result profiles, or perform any other search review as may be known in the art.

In one embodiment, the Search User may solicit approval from the Friend. Match User before attempting to establish or confirm a match with a selected search result profile, In another embodiment, the Friend Match User may immediately attempt to establish a match, i.e., by providing approval for the FDMS to present the Friend Match User profile to a selected search result profile as a possible match.

As is well known in the art the FDMS may provide multiple means for its users to communicate, either anonymously, partially anonymously, or otherwise, through means such as smart phone apps, email, in-app messaging, text message, video or audio messages, etc.

In one embodiment, friends may add “friend attributes,” i.e., attributes or descriptions from a friend or a user, to a user, rather than from the user himself or herself.

In one embodiment, a Search User may attempt to simply match FDMS profiles, regardless of whether the Search User knows either of the individuals associated with the FDMS profiles, or how well the Search User may be acquainted with one or more FDMS user profiles. In one embodiment, a user may approve being randomly matched by another user, or may approve a particular list of trusted matchmakers, or may identify particular characteristics that a particular Search User (e.g., matchmaker) must have.

In one embodiment, a FDMS user may indicate, with or her FDMS profile, availability for particular dates and/or times.

In one embodiment, a FDMS user may request that a FDMS Search User, a friend, find one or more matches for the FDMS user, or find a match for a particular date and/or time for a FDMS Search User. For example, a FDMS user MackSmith may send a request, within or outside of FDMS, to his friend BillBrown, for Bill to find for MackSmith a potential date for an upcoming Friday at 8:00 pm to see a show.

In one embodiment, the FDMS may rank or rate Search Users. For example, a Search User may be rated or ranked based on feedback from FDMS users or others, on the accuracy of one or more matches, or by testing a Search User based on accuracy (unknown to the Search User) the time of testing of historical matches or match possibilities, or based on a comparison of a Search User's match decisions to decisions of other Search Users for the same or similar possible matches, and other ways known in the art. The FDMS may further rank a Search User, in whole or in part, based on subsequent feedback, reporting, or follow-up relating to one or more particular matches, e.g., the matched parties' respective satisfaction with the match; whether messages and/or phone calls and/or emails result from the match; number, length, or content of messages and/or phone calls and/or emails that result from the match; number of dates resulting from the match; length of relationship resulting from the match; marriages or long term relationships) resulting from the match; and/or other metrics that may be known in the art or within the skill of a person of skill in the art.

The FDMS may also rate or rank a Search User for a particular segment of FDMS profiles, e.g., a particular Search User may be especially adept or adroit at finding matches for redheads, or by geography, etc.

Ranking may be based on a point system, or a numerical system, or on any other system for ranking known in the art.

In addition to ranking, the FDMS may award points or other incentives to Search Users for successful matches. The metrics for successful matches may include the same metrics as those for ranking a Search User, as described herein. In one embodiment, a Search User may be able to redeem earned points or incentives for free or discounted date activities, gift cards, financial rewards, or any other award that may reward or centivize successful matching by a Search User.

In one embodiment, the FDMS may publish or otherwise make available Search User rankings, e.g., top ten Search Users across the world, or in a locality, or across a particular segment of the user population hair color, occupation, etc.)

In one embodiment, a first user desiring for another to find a match for himself/herself may select a particular matchmaker (SearchUser) by rating or ranking, or may select the attributes for matchmaker (Search User) using rating, ranking, or other attributes about a particular matchmaker's (Search User's) matchmaking history and/or success.

in one embodiment, a user may select one or more “wingmen.” A wingman is a filter for potential matches. For example, a FDMS user may select a close friend as his wingman. Before a possible match is presented to the user, the FDMS may require the wingman to approve the proposed match, or possibly to provide comments to the FDMS about what the wingman thinks about the suggested match.

In one embodiment, a match may be based on input from multiple Search Users, e.g., through a voting scheme or other collaborative scheme or other scheme that combines input from multiple Search Users to generate a decision on whether to generate a match.

In some embodiments, matching may be anonymous or partially anonymous, e.g., one or both of the users being matched may not know the identity of the FDMS user(s) involved in generating the match.

The system and method disclosed herein may be used for applications other than dating. For example, the invention disclosed herein could be used for business to find employees or customers, or for bands to find new members, or vice versa. A person of ordinary skill will recognize that the approach disclosed herein could be applied, with simple modification, to many scenarios in which two are more entities (businesses, people, families)need matches for various reasons.

In some embodiments, the FDMS may incorporate one or more revenue generation mechanisms. For example, advertisements may be presented to a user, for an opportunity for the user to link the advertisement to his or her friend(s), save the advertisement for later, skip it, or reject it. in another example, the FDMS may present vouchers, discounts, deals, or suggestions for dates and/or activities, and the FDMS may receive a commission from associated sales.

What is claimed is:

1. A method for matching, comprising:
identifying a first profile;
presenting one or more profiles from a set of pool profiles to a search user;
receiving from the search user a selection from the one or more pool profiles; and
generating a match based on the search user's selection from the one or more pool profiles.

2. The method of claim 1, wherein:
the matching is for dating and/or romantic purposes;
the first profile is associated with a person; and
each profile in the set of pool profiles is associated with a person.

3. The method of claim 2, wherein the search user and the first profile are friends.

4. The method of claim 2, wherein identifying a first profile comprises receiving a selection of a first profile from the search user.

5. The method of claim 2, wherein the search user is selected by the first profile.

6. The method of claim 2, wherein presenting one or more profiles from a set of pool profiles further comprises generating the set of pool profiles based on criteria received from the search user.

7. The method of claim 2, wherein presenting one or more profiles from a set of pool profiles comprises presenting the one or more profiles from the set of pool profiles in an order based on criteria from the search user or from the first profile.

8. The method of claim 2, wherein generating a match based on the search user's selection from the one or more pool profiles comprises generating a match comprising the first profile and the search user's selection from the one or more pool profiles.

9. The method of claim 2, wherein generating a match based on the search user's selection from the one or more pool profiles comprises uses a voting scheme for generating a match based on the search user's selection and on input from one or more other users.

10. The method of claim 2, wherein generating a match based on the search user's selection from the one or more pool profiles further comprises receiving approval from one or more other users.

11. The method of claim 2, further comprising assigning a matching score to the search user based at least n part on one or more match outcomes associated with the search user.

12. The method of claim 11, wherein the search user is selected based at least in part on the matching score assigned to the search user.

13. The method of claim 11, wherein one or more matching scores for one or more search users are presented to the first profile, and the search user is selected by the first profile.

14. The method of claim 1, wherein a generated match is presented to at least one of the first profile and the search user.

15. The method of claim 14, wherein the generated match is presented anonymously.

16. A system for matching, comprising:
a user device configured to transmit data to and receive data from a user device, wherein the user device includes instructions that when executed cause the user device to:
identify a first profile;
present one or more profiles from a set of pool profiles to a search user;
receive from the search user a selection from the one or more pool profiles; and
generate a match based on the search user's selection from the one or more pool profiles.

17. The system of claim 16, wherein:
the matching is for dating and/or romantic purposes;
the first profile is associated with a person; and
each profile in the set of pool profiles is associated with a person.

18. The system of claim 17, wherein the search user and the first profile are friends.

19. The system of claim 17, wherein identifying a first profile comprises receiving a selection of a first profile from the search user.

20. The system of claim 17, wherein the search user is selected by the first profile.
